(19) United States
(12) Patent Application Publication
(10) Pub. No.: US 2021/0139634 A1
(43) Pub. Date: May 13, 2021

(54) USE OF ACRYLIC ACID ESTERS AND AMIDES FOR REDUCING EMISSIONS OF A POLYURETHANE FOAM

(71) Applicant: Covestro Deutschland AG, Leverkusen (DE)

(72) Inventors: Rolf Albach, Köln (DE); Hans-Detlef Arntz, Overath (DE); Petra Venner, Leverkusen (DE)

(21) Appl. No.: 17/152,853

(22) Filed: Jan. 20, 2021

Related U.S. Application Data
(62) Division of application No. 16/466,380, filed on Jun. 4, 2019.

(30) Foreign Application Priority Data
Dec. 5, 2016 (EP) 16202104.2

(51) Int. Cl. C08G 18/48; C08G 18/76; C08G 18/81; C08G 18/67

(52) U.S. Cl. CPC C08G 18/4812; C08G 18/7671; C08G 18/4841; C08G 2110/0066; C08G 18/672; C08G 2110/005; C08G 2110/0058; C08G 18/8175

(57) ABSTRACT

The present invention relates to the use
i) of one or more compounds selected from the group consisting of

R¹R²C═CR³—C(O)—O—R⁴ (I.),

R⁵R⁶C═CR⁷—C(O)—O—R⁸—O—(O)C—R⁹C═CR¹⁰R¹¹ (II.),

R¹²R¹³C═CR¹⁴—C(O)—O—(O)C—R¹⁴C═CR¹³R¹² (III.) and

R¹⁵R¹⁶C═CR¹⁷—C(O)—NR¹⁸—R¹⁹ (IV.),
wherein
R¹ and R², R⁴ to R⁷ and R⁹ to R¹⁹ independently of one another represent H, a saturated or unsaturated, linear or branched, aliphatic or cycloaliphatic or an aromatic or araliphatic radical having up to 20 carbon atoms which may optionally contain heteroatoms such as N, S or O and which may optionally be substituted, for example by isocyanate-reactive groups, preferably by OH groups,
R³ represents H,
and
R⁸ represents a saturated or unsaturated, linear or branched, aliphatic divalent radical having up to 20 carbon atoms which may optionally contain heteroatoms such as N, S or O and which may optionally be substituted, for example by isocyanate-reactive groups, preferably by OH groups,
and/or
ii) of polyester polyols, preferably polyester diols, obtainable by polycondensation of maleic acid, fumaric acid, methacrylic acid or acrylic acid with oligomeric diols such as butanediol, diethylene glycol, propylene glycol, 1,3-propanediol and/or triols such as glycerol having a molecular weight factor per double bond of 150 to 3000, a functionality of 2 to 6, a hydroxyl number of 20 to 800 and an acid number of 0 to 15
   in processes for producing polyurethanes, preferably polyurethane foams, for reducing the aldehyde emission of the resulting polyurethanes/polyurethane foams, to a process for producing polyurethanes, preferably polyurethane foams, using one or more compounds of formula IV and to polyurethanes obtainable from this process.

It is known from the prior art that polyurethane foams can emit aldehydes, these aldehyde emissions generally being unwanted. These emissions are detected for example in measurements according to VDA 275 (flask method, 60° C.) or else according to VDA 276 (emissions chamber test, 65° C.).

WO2015082316 describes that certain cyanoacetamides can be suitable for reducing the emissions of formaldehyde from foams. Furthermore, WO2015082316 describes that certain esters of cyanoacetic acid and of 3-oxocarboxylic acids can be suitable therefor.

JP 2004129926 describes a polymerized acrylate resin (largely free from unsaturated double bonds) for absorption of formaldehyde. This employs the known activity of acetoacetates (WO2015082316) which the inventors have attached to the acrylate resin.

DE 199 19 826 describes the use of certain additives, for example α,β-unsaturated carboxylic acid derivatives, in the production of polyurethane foams for reducing the content of primary aromatic amines. The use of such compounds in the production of polyurethanes for reducing the aldehyde emission of the resulting polyurethanes is not disclosed.

The present invention has for its object to provide polyurethanes, preferably polyurethane foams, exhibiting even lower aldehyde emission (formaldehyde and acetaldehyde) than polyurethanes/polyurethane foams of the prior art.

This object is achieved through the use of isocyanate-reactive acrylic esters and amides and derivatives thereof in the production of the polyurethanes.

The present invention accordingly provides for the use of α,β-unsaturated carboxylic esters and/or amides in processes for producing polyurethanes, preferably polyurethane foams, for reducing the aldehyde emission of the resulting polyurethanes/polyurethane foams.

Preferred in accordance with the present invention is the use
i) of one or more compounds selected from the group consisting of

R¹R²C═CR³—C(O)—O—R⁴ (I.),

R⁵R⁶C═CR⁷—C(O)—O—R⁸—O—(O)C—R⁹C═CR¹⁰R¹¹ (II.),

R¹²R¹³C═CR¹⁴—C(O)—O—(O)C—R¹⁴C═CR¹³R¹² (III.) and

R¹⁵R¹⁶C═CR¹⁷—C(O)—NR¹⁸—R¹⁹ (IV.),
wherein
   R¹ and R², R⁴ to R⁷ and R⁹ to R¹⁹ independently of one another represent H, a saturated or unsaturated, linear or branched, aliphatic or cycloaliphatic or an aromatic or araliphatic radical having up to 20 carbon atoms which may optionally contain heteroatoms such as N, S or O and which may optionally be substituted, for example by isocyanate-reactive groups, preferably by OH groups,
   R³ represents H,
   and
   R⁸ represents a saturated or unsaturated, linear or branched, aliphatic divalent radical having up to 20 carbon atoms which may optionally contain heteroatoms such as N, S or O and which may optionally be substituted, for example by isocyanate-reactive groups, preferably by OH groups,
and/or
ii) of polyester polyols, preferably polyester diols, obtainable by polycondensation of maleic acid, fumaric acid, methacrylic acid or acrylic acid with oligomeric diols such as butanediol, diethylene glycol, propylene glycol, 1,3-propanediol and/or triols such as glycerol having a molecular weight factor per double bond of 150 to 3000, a functionality of 2 to 6, a hydroxyl number of 20 to 800 and an acid number of 0 to 15
   in processes for producing polyurethanes, preferably polyurethane foams, for reducing the aldehyde emission of the resulting polyurethanes/polyurethane foams.

Should there be compounds which conform both to the definition of component (ii) and to the definition of component (II) these compounds shall be assigned to the component (ii).

Particularly preferred in accordance with the present invention is the use
i) of one or more compounds selected from the group consisting of

R¹R²C═CR³—C(O)—O—R⁴ (I.),

R⁵R⁶C═CR⁷—C(O)—O—R⁸—O—(O)C—R⁹C═CR¹⁰R¹¹ (II.),

R¹²R¹³C═CR¹⁴—C(O)—O—(O)C—R¹⁴C═CR¹³R¹² (III.) and

R¹⁵R¹⁶C═CR¹⁷—C(O)—NR¹⁸—R¹⁹ (IV.),
wherein
   R¹ and R², R⁴ to R⁷ and R⁹ to R¹⁹ independently of one another represent H, a saturated or unsaturated, linear or branched, aliphatic or cycloaliphatic or an aromatic or araliphatic radical having up to 20 carbon atoms which may optionally contain heteroatoms such as N, S or O and which may optionally be substituted, for example by isocyanate-reactive groups, preferably OH groups, R³ represents H,
   R⁸ represents a saturated or unsaturated, linear or branched, aliphatic divalent radical having up to 20 carbon atoms which may optionally contain heteroatoms such as N, S or O and which may optionally be substituted, for example by isocyanate-reactive groups, preferably by OH groups,
and/or
ii) of polyester polyols, preferably polyester diols, obtainable by polycondensation of maleic acid, fumaric acid, methacrylic acid or acrylic acid with oligomeric diols such as butanediol, diethylene glycol, propylene glycol, 1,3-propanediol and/or triols such as glycerol having a molecular weight factor per double bond of 150 to 3000, a functionality of 2 to 6, a hydroxyl number of 20 to 800 and an acid number of 0 to 15
   in processes for producing polyurethane foams for reducing the aldehyde emission of the resulting polyurethane foams, wherein the production of the polyurethane foams is by reaction of a component A containing:
A1 compounds containing isocyanate-reactive hydrogen atoms having an OH number according to DIN 53240 of ≥15 to <260 mg KOH/g,
A2 optionally compounds containing isocyanate-reactive hydrogen atoms having an OH number according to DIN 53240 of ≥260 to <4000 mg KOH/g,
A3 water and/or physical blowing agents,
A4 auxiliary and/or additive substances such as
   a) catalysts,
   b) surface-active additive substances,
   c) pigments and/or flame retardants,
   wherein free-radical initiators and catalysts which catalyze a vinylic polymerization are excluded,
      and a component B, which comprises one or more compounds selected from the group consisting of (I) to (IV) and (ii),
      with
      C di- and/or polyisocyanates.

The usage amount of the inventive component B based on 1 kg of the components A1 and C is 1 to 100 g, preferably 5 to 50 g (the value of 1 kg relates to the sum of A1 and C).

Component B is subjected to non-vinylic polymerization.

Very particularly preferred in accordance with the present invention (alternative I) is the use
i) of one or more compounds selected from the group consisting of

R¹R²C═CR³—C(O)—O—R⁴ (I.),

R⁵R⁶C═CR⁷—C(O)—O—R⁸—O—(O)C—R⁹C═CR¹⁰R¹¹ (II.),

R¹²R¹³C═CR¹⁴—C(O)—O—(O)C—R¹⁴C═CR¹³R¹² (III.) and

R¹⁵R¹⁶C═CR¹⁷—C(O)—NR¹⁸—R¹⁹ (IV.),
wherein
   R¹ and R², R⁴ to R⁷ and R⁹ to R¹⁹ independently of one another represent H, a saturated or unsaturated, linear or branched, aliphatic or cycloaliphatic or an aromatic or araliphatic radical having up to 20 carbon atoms which may optionally contain heteroatoms such as N, S or O and which may optionally be substituted, for example by isocyanate-reactive groups, preferably OH groups,
R³ represents H,
R⁸ represents a saturated or unsaturated, linear or branched, aliphatic divalent radical having up to 20 carbon atoms which may optionally contain heteroatoms such as N, S or O and which may optionally be substituted, for example by isocyanate-reactive groups, preferably by OH groups,
   and/or
ii) of polyester polyols, preferably polyester diols, obtainable by polycondensation of maleic acid, fumaric acid, methacrylic acid or acrylic acid with oligomeric diols such as butanediol, diethylene glycol, propylene glycol, 1,3-propanediol and/or triols such as glycerol having a molecular weight factor per double bond of 150 to 3000, a functionality of 2 to 6, a hydroxyl number of 20 to 800 and an acid number of 0 to 15
   in processes for producing polyurethane foams for reducing the aldehyde emission of the resulting polyurethane foams, wherein the production of the polyurethane foams is by reaction of a component A containing:
A1 75 to 99.3 parts by weight (based on the sum of the parts by weight of components A1 to A4) of compounds containing isocyanate-reactive hydrogen atoms having an OH number according to DIN 53240 of ≥15 to <260 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.8 parts by weight (based on the sum of the parts by weight of components A1 to A4) of water and/or physical blowing agents,
A4 0.2 to 10 parts by weight (based on the sum of the parts by weight of components A1 to A4) of auxiliary and additive substances such as
   a) catalysts,
   b) surface-active additive substances,
   c) pigments and/or flame retardants,
   wherein free-radical initiators and catalysts which catalyze a vinylic polymerization are excluded,
      and 1 to 100 g per kg of the components A1 and C, preferably 5 to 50 g per kg of the components A1 and C, of a component B which comprises one or more compounds selected from the group consisting of (I) to (IV) and (ii),
      with
      C di- and/or polyisocyanates,
      wherein all reported parts by weight for the components A1 to A4 are normalized such that the sum of the parts by weight of the components A1+A2+A3+A4 in the composition adds up to 100.

Likewise very particularly preferred (alternative II) is the use
i) of one or more compounds selected from the group consisting of

R¹R²C═CR³—C(O)—O—R⁴ (I.),

R⁵R⁶C═CR⁷—C(O)—O—R⁸—O—(O)C—R⁹C═CR¹⁰R¹¹ (II.),

R¹²R¹³C═CR¹⁴—C(O)—O—(O)C—R¹⁴C═CR¹³R¹² (III.) and

R¹⁵R¹⁶C═CR¹⁷—C(O)—NR¹⁸—R¹⁹ (IV.),
wherein
   R¹ and R², R⁴ to R⁷ and R⁹ to R¹⁹ independently of one another represent H, a saturated or unsaturated, linear or branched, aliphatic or cycloaliphatic or an aromatic or araliphatic radical having up to 20 carbon atoms which may optionally contain heteroatoms such as N, S or O and which may optionally be substituted, for example by isocyanate-reactive groups, preferably OH groups,
R³ represents H,
R⁸ represents a saturated or unsaturated, linear or branched, aliphatic divalent radical having up to 20 carbon atoms which may optionally contain heteroatoms such as N, S or O and which may optionally be substituted, for example by isocyanate-reactive groups, preferably by OH groups,
   and/or
ii) of polyester polyols, preferably polyester diols, obtainable by polycondensation of maleic acid, fumaric acid, methacrylic acid or acrylic acid with oligomeric diols such as butanediol, diethylene glycol, propylene glycol, 1,3-propanediol and/or triols such as glycerol having a molecular weight factor per double bond of 150 to 3000, a functionality of 2 to 6, a hydroxyl number of 20 to 800 and an acid number of 0 to 15
   in processes for producing polyurethane foams for reducing the aldehyde emission of the resulting polyurethane foams, wherein the production of the polyurethane foams is by reaction of a component A containing:
A1 25 to 45 parts by weight (based on the sum of the parts by weight of components A1 to A4) of compounds containing isocyanate-reactive hydrogen atoms having an OH number according to DIN 53240 of ≥15 to <260 mg KOH/g,
A2 20 to 74.3 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.2 to 10 parts by weight (based on the sum of the parts by weight of components A1 to A4) of auxiliary and additive substances such as
   a) catalysts,
   b) surface-active additive substances,
   c) pigments and/or flame retardants,
   wherein free-radical initiators and catalysts which catalyze a vinylic polymerization are excluded,
      and 1 to 100 g per kg of the components A1 and C, preferably 5 to 50 g per kg of the components A1 and C, of a component B which comprises one or more compounds selected from the group consisting of (I) to (IV) and (ii),
      with
      C di- and/or polyisocyanates,
      wherein all reported parts by weight for the components A1 to A4 are normalized such that the sum of the parts by weight of the components A1+A2+A3+A4 in the composition adds up to 100.

The present invention further provides a process for producing polyurethanes, preferably polyurethane foams, by reaction of compounds containing isocyanate-reactive hydrogen atoms with di- and/or polyisocyanates in the presence of α,β-unsaturated carboxamides.

Preferred in accordance with the present invention is a process for producing polyurethanes, preferably polyurethane foams, by reaction of compounds containing isocyanate-reactive hydrogen atoms with di- and/or polyisocyanates in the presence of one or more compounds of the formula

R¹⁵R¹⁶C═CR¹⁷—C(O)—NR¹⁸—R¹⁹ (IV.),
wherein
R¹⁵ to R¹⁹ independently of one another represent H, a saturated or unsaturated, linear or branched, aliphatic or cycloaliphatic or an aromatic or araliphatic radical having up to 20 carbon atoms which may optionally contain heteroatoms such as N, S or O and which may optionally be substituted, for example by isocyanate-reactive groups, preferably by OH groups.

The present invention also provides the polyurethanes/polyurethane foams obtainable by the described process.

The present invention in particular provides a process for producing polyurethane foams in which a component A containing
A1 compounds containing isocyanate-reactive hydrogen atoms having an OH number according to DIN 53240 of ≥15 to <260 mg KOH/g,
A2 optionally compounds containing isocyanate-reactive hydrogen atoms having an OH number according to DIN 53240 of ≥260 to <4000 mg KOH/g,
A3 water and/or physical blowing agents,
A4 auxiliary and additive substances such as
   a) catalysts,
   b) surface-active additive substances,
   c) pigments and/or flame retardants,
   wherein free-radical initiators and catalysts which catalyze a vinylic polymerization are excluded,
      and a component B which comprises one or more compounds of the formula

R¹⁵R¹⁶C═CR¹⁷—C(O)—NR¹⁸—R¹⁹ (IV.),
wherein
R¹⁵ to R¹⁹ independently of one another represent H, a saturated or unsaturated, linear or branched, aliphatic or cycloaliphatic or an optionally substituted aromatic or araliphatic radical having up to 20 carbon atoms which may optionally contain heteroatoms such as N, S or O and which may optionally be substituted, for example by isocyanate-reactive groups, preferably by OH groups,
   are reacted with
   C di- and/or polyisocyanates.

The usage amount of the inventive component B based on 1 kg of the components A1 and C is 1 to 100 g, preferably 5 to 50 g (the value of 1 kg relates to the sum of A1 and C.

Very particularly preferred (alternative I) is a process for producing polyurethane foams in which a component A containing
A1 75 to 99.3 parts by weight (based on the sum of the parts by weight of components A1 to A4) of compounds containing isocyanate-reactive hydrogen atoms having an OH number according to DIN 53240 of ≥15 to <260 mg KOH/g,
A2 0 to 10 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 24.8 parts by weight (based on the sum of the parts by weight of components A1 to A4) of water and/or physical blowing agents,
A4 0.2 to 10 parts by weight (based on the sum of the parts by weight of components A1 to A4) of auxiliary and additive substances such as
   a) catalysts,
   b) surface-active additive substances,
   c) pigments and/or flame retardants,
   wherein free-radical initiators and catalysts which catalyze a vinylic polymerization are excluded,
      and
      1 to 100 g per kg of the components A1 and C, preferably 5 to 50 g per kg of the components A1 and C, of a component B which comprises one or more compounds of the formula

R¹⁵R¹⁶C═CR¹⁷—C(O)—NR¹⁸—R¹⁹ (IV.),
wherein
R¹⁵ to R¹⁹ independently of one another represent H, a saturated or unsaturated, linear or branched, aliphatic or cycloaliphatic or an optionally substituted aromatic or araliphatic radical having up to 20 carbon atoms which may optionally contain heteroatoms such as N, S or O and which may optionally be substituted, for example by isocyanate-reactive groups, preferably by OH groups,
   are reacted with
   C di- and/or polyisocyanates,
   wherein all reported parts by weight for the components A1 to A4 are normalized such that the sum of the parts by weight of the components A1+A2+A3+A4 in the composition adds up to 100.

Likewise very particularly preferred (alternative II) is a process for producing polyurethane foams in which
A1 25 to 45 parts by weight (based on the sum of the parts by weight of components A1 to A4) of compounds containing isocyanate-reactive hydrogen atoms having an OH number according to DIN 53240 of ≥15 to <260 mg KOH/g,
A2 20 to 74.3 parts by weight (based on the sum of the parts by weight of components A1 to A4) of compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents, preferably 2-7 parts by weight of water,
A4 0.2 to 10 parts by weight (based on the sum of the parts by weight of components A1 to A4) of auxiliary and additive substances such as
   a) catalysts,
   b) surface-active additive substances,
   c) pigments and/or flame retardants,
   wherein free-radical initiators and catalysts which catalyze a vinylic polymerization are excluded,
      and

1 to 100 g per kg of the components A1 and C, preferably 5 to 50 g per kg of the components A1 and C, of a component B which comprises one or more compounds of the formula

R¹⁵R¹⁶C═CR¹⁷—C(O)—NR¹⁸—R¹⁹ (IV.),
wherein
R¹⁵ to R¹⁹ independently of one another represent H, a saturated or unsaturated, linear or branched, aliphatic or cycloaliphatic or an optionally substituted aromatic or araliphatic radical having up to 20 carbon atoms which may optionally contain heteroatoms such as N, S or O and which may optionally be substituted, for example by isocyanate-reactive groups, preferably by OH groups,
   are reacted with
   C di- and/or polyisocyanates,
   wherein all reported parts by weight for the components A1 to A4 are normalized such that the sum of the parts by weight of the components A1+A2+A3+A4 in the composition adds up to 100.

The production of isocyanate-based foams is known per se and described for example in DE-A 1 694 142, DE-A 1 694 215 and DE-A 1 720 768 and also in Kunststoff-Handbuch volume VII, Polyurethane, edited by Vieweg and Höchtlein, Carl Hanser Verlag, Munich 1966, and in the new edition of this book, edited by G. Oertel, Carl Hanser Verlag Munich, Vienna 1993.

The production of the isocyanate-based foams may employ the components more particularly described hereinbelow.

### Component A1

Starting components according to component A1 are compounds having at least two isocyanate-reactive hydrogen atoms having an OH number according to DIN 53240 of ≥15 to <260 mg KOH/g.

This is to be understood as meaning not only amino-containing but also thiol-containing or carboxyl-containing compounds, preferably hydroxyl-containing compounds, in particular compounds containing 2 to 8 hydroxyl groups, specifically those having an OH number according to DIN 53240 of ≥20 to ≤150 mg KOH/g, preferably ≥20 to ≤50 mg KOH/g, very particularly preferably ≥25 to ≤45 mg KOH/g, for example polyethers and polyesters and also polycarbonates and polyesteramides containing at least 2, generally 2 to 8, but preferably 2 to 6, hydroxyl groups, such as are known per se for the production of homogeneous and of cellular polyurethanes and as are described for example in EP-A 0 007 502, pages 8-15. Polyethers and polyesters containing at least two hydroxyl groups are preferred according to the invention. Polyethers containing at least two hydroxyl groups are particularly preferred.

The production of the polyether polyols is carried out by known methods, preferably by base-catalyzed polyaddition of alkylene oxides onto polyfunctional starter compounds containing active hydrogen atoms, for example alcohols or amines. Examples include: ethylene glycol, diethylene glycol, 1,2-propylene glycol, 1,4-butanediol, hexamethylene glycol, bisphenol A, trimethylolpropane, glycerol, pentaerythritol, sorbitol, sucrose, degraded starch, water, methylamine, ethylamine, propylamine, butylamine, aniline, benzylamine, o- and p-toluidine, α,β-naphthylamine, ammonia, ethylenediamine, propylenediamine, 1,4-butylenediamine, 1,2-, 1,3-, 1,4-, 1,5- and/or 1,6-hexamethylenediamine, o-, m-, and p-phenylenediamine, 2,4-, 2,6-tolylenediamine, 2,2′-, 2,4- and 4,4′-diaminodiphenylmethane and diethylenediamine.

Preferably employed as alkylene oxides are ethylene oxide, propylene oxide, butylene oxide and mixtures thereof. The construction of the polyether chains by alkoxylation may be performed with only one monomeric epoxide or else in random or blockwise fashion with two or three different monomeric epoxides.

Processes for producing such polyether polyols are described in “Kunststoffhandbuch, volume 7, Polyurethane”, in “Reaction Polymers” and for example in U.S. Pat. Nos. 1,922,451, 2,674,619, 1,922,459, 3,190,927 and 3,346,557.

The polyaddition may also be carried out with DMC catalysis for example. DMC catalysts and the use thereof for producing polyether polyols are described for example in U.S. Pat. Nos. 3,404,109, 3,829,505, 3,941,849, 5,158,922, 5,470,813, EP-A 700 949, EP-A 743 093, EP-A 761 708, WO-A 97/40086, WO-A 98/16310 and WO-A 00/47649.

In a particularly preferred embodiment component A1 contains at least 30% by weight of at least one polyoxyalkylene polymer consisting of a starter, propylene oxide and optionally ethylene oxide and optionally an end block made of ethylene oxide, wherein the total weight of the end blocks is on average 3-20% by weight, preferably 5-15% by weight, particularly preferably 6-10% by weight, based on the total weight of all polyoxyalkylene polymers.

In addition to the above-described “simple” polyether polyols the process according to the invention may also employ polyether carbonate polyols. Polyether carbonate polyols are obtainable for example by catalytic reaction of ethylene oxide and propylene oxide, optionally further alkylene oxides and carbon dioxide in the presence of H-functional starter substances (see for example EP-A 2046861).

Methods for producing polyester polyols are likewise well known and described for example in the two abovementioned citations (“Kunststoffhandbuch, volume 7, Polyurethane”, “Reaction Polymers”). The polyester polyols are produced inter alia by polycondensation of polyfunctional carboxylic acids or derivatives thereof, for example acid chlorides or anhydrides, with polyfunctional hydroxyl compounds.

Employable polyfunctional carboxylic acids include for example: adipic acid, phthalic acid, isophthalic acid, terephthalic acid, oxalic acid, succinic acid, glutaric acid, azelaic acid, sebacic acid, fumaric acid or maleic acid.

Employable polyfunctional hydroxyl compounds include for example: ethylene glycol, diethylene glycol, triethylene glycol, 1,2-propylene glycol, dipropylene glycol, 1,3-butanediol, 1,4-butanediol, 1,6-hexanediol, 1,12-dodecanediol, neopentyl glycol, trimethylolpropane, triethylolpropane or glycerol.

Production of the polyester polyols may moreover also be effected by ring-opening polymerization of lactones (for example caprolactone) with diols and/or triols as starters.

Also employable in component A1 as hydroxyl-containing compounds of the component A1 are polymer polyols, PUD polyols and PIPA polyols. Polymer polyols are polyols containing proportions of solid polymers produced by free-radical polymerization of suitable monomers such as styrene or acrylonitrile in a base polyol. PUD (polyurea dispersion) polyols are produced for example by in-situ polymerization of an isocyanate or an isocyanate mixture with a diamine and/or hydrazine in a polyol, preferably a polyether polyol. The PUD dispersion is preferably produced by reaction of an isocyanate mixture of 75% to 85% by weight of 2,4-tolylene diisocyanate (2,4-TDI) and 15 to 25% by weight of 2,6-tolylene diisocyanate (2,6-TDI) with a diamine and/or hydrazine in a polyether polyol, preferably a polyether polyol, produced by alkoxylation of a trifunctional starter (for example glycerol and/or trimethylolpropane). Processes for preparing PUD dispersions are described, for example, in U.S. Pat. Nos. 4,089,835 and 4,260,530. PIPA polyols are polyether polyols modified with alkanolamines by polyisocyanate-polyaddition, wherein the polyether polyol has a functionality of from 2.5 to 4 and a hydroxyl number of from ≥3 mg KOH/g to ≤112 mg KOH/g (molecular weight from 500 to 18 000). PIPA polyols are described in detail in GB 2 072 204 A, DE 31 03 757 A1 and U.S. Pat. No. 4,374,209 A.

### Component A2

Optionally employed as component A2 are compounds having at least two isocyanate-reactive hydrogen atoms and an OH number according to DIN 53240 of ≥260 to <4000 mg KOH/g, preferably ≥400 to ≤3000 mg KOH/g, particularly preferably ≥1000 to ≤2000 mg KOH/g.

These include compounds having hydroxyl groups and optionally amino groups, thiol groups or carboxyl groups, preferably compounds containing hydroxyl groups and optionally amino groups.

These compounds have preferably 2 to 8, particularly preferably 2 to 4, isocyanate-reactive hydrogen atoms.

These may be for example low molecular weight diols (for example 1,2-ethanediol, 1,3- or 1,2-propanediol, 1,4-butanediol), triols (for example glycerol, trimethylolpropane), tetraols (for example pentaerythritol), hexaols (for example sorbitol) or amino alcohols (ethanolamine, diethanolamine, triethanolamine).

However, they may also be short chain polyether polyols, polyether carbonate polyols, polyester polyols, polyester carbonate polyols, polythioether polyols, polyacrylate polyols or polycarbonate polyols.

For production of these polymers (reactants, processes) reference is made to what is stated above in connection with component A1.

Further examples of compounds for component A2 are described in EP-A 0 007 502, pages 16-17.

### Component A3

Water and/or physical blowing agents are used as component A3. Physical blowing agents used are, for example, carbon dioxide and/or volatile organic substances.

### Component A4

Optionally used as component A4 are auxiliary and additive substances such as
a) catalysts (activators),
b) surface-active additive substances (surfactants), such as emulsifiers and foam stabilizers, in particular those with low emission such as for example products of the Tegostab® LF series,
c) additives such as reaction retardants (for example acidic substances such as hydrochloric acid or organic acid halides), cell regulators (for example paraffins or fatty alcohols or dimethylpolysiloxanes), pigments, dyes, flame retardants (for example tricresyl phosphate), stabilizers against aging and weathering effects, plasticizers, fungistatic and bacteriostatic substances, fillers (for example barium sulfate, kieselguhr, carbon black chalk or precipitated chalk) and release agents.

These auxiliaries and additives for optional additional use are described, for example, in EP-A 0 000 389, pages 18-21. Further examples of auxiliaries and additives for optional additional use in accordance with the invention and details of the manner of use and mode of action of these auxiliaries and additives are described in Kunststoff-Handbuch [Plastics Handbook], volume VII, edited by G. Oertel, Carl-Hanser-Verlag, Munich, 3rd edition, 1993, for example on pages 104-127.

Preferred catalysts are aliphatic tertiary amines (for example trimethylamine, tetramethylbutanediamine), cycloaliphatic tertiary amines (for example 1,4-diaza[2.2.2]bicyclooctane), aliphatic amino ethers (for example dimethylaminoethyl ether and N,N,N-trimethyl-N-hydroxyethylbisaminoethyl ether), cycloaliphatic amino ethers (for example N-ethylmorpholine), aliphatic amidines, cycloaliphatic amidines, urea, derivatives of urea (for example aminoalkylureas; see, for example, EP-A 0 176 013), especially (3-dimethylaminopropylamine)urea), and tin catalysts (for example dibutyltin oxide, dibutyltin dilaurate, tin octoate).

Particularly preferred catalysts are a) urea, derivatives of urea and/or b) the abovementioned amines and amino ethers, characterized in that the amines and amino ethers contain a functional group that undergoes chemical reaction with the isocyanate. Preferably, the functional group is a hydroxyl group, a primary or secondary amino group. These particularly preferred catalysts have the advantage of having greatly reduced migration and emission characteristics. Examples of particularly preferred catalysts include: (3-dimethylaminopropylamine)urea, 1,1′-((3-(dimethylamino)propyl)imino)bis-2-propanol, N-[2-[2-(dimethylamino)ethoxy]ethyl]-N-methyl-1,3-propanediamine and 3-dimethylaminopropylamine.

Excluded from component A4 are free-radical initiators and catalysts which catalyze a vinylic polymerization.

### Component B

Component B comprises
i) compounds selected from the group consisting of:

R¹R²C═CR³—C(O)—O—R⁴ (I.),

R⁵R⁶C═CR⁷—C(O)—O—R⁸—O—(O)C—R⁹C═CR¹⁰R¹¹ (II.),

R¹²R¹³C═CR¹⁴—C(O)—O—(O)C—R¹⁴C═CR¹³R¹² (III.) and

R¹⁵R¹⁶C═CR¹⁷—C(O)—NR¹⁸—R¹⁹ (IV.),
wherein
R¹ and R², R⁴ to R⁷ and R⁹ to R¹⁹ independently of one another represent H, a saturated or unsaturated, linear or branched, aliphatic or cycloaliphatic or an aromatic or araliphatic radical having up to 20 carbon atoms which may optionally contain heteroatoms such as N, S or O and which may optionally be substituted, for example by isocyanate-reactive groups, preferably by OH groups,
R³ represents H,
and
R⁸ represents a saturated or unsaturated, linear or branched, aliphatic divalent radical having up to 20 carbon atoms which may optionally contain heteroatoms such as N, S or O and which may optionally be substituted, for example by isocyanate-reactive groups, preferably by OH groups,
   and
ii) polyester polyols, preferably polyester diols, obtainable by polycondensation of maleic acid, fumaric acid, methacrylic acid or acrylic acid with oligomeric diols such as butanediol, diethylene glycol, propylene glycol, 1,3-propanediol and/or triols such as glycerol having a molecular weight factor per double bond of 150 to 3000, a functionality of 2 to 6, a hydroxyl number of 20 to 800 and an acid number of 0 to 15.

It is preferable when in i) the radicals R¹ and R², R⁴ to R¹⁹ independently of one another represent H, a saturated or unsaturated, linear or branched, aliphatic or cycloaliphatic or an aromatic or araliphatic radical having up to 12 carbon atoms which may optionally contain O atoms as heteroatoms and which may optionally be substituted, for example by isocyanate-reactive groups, preferably by OH groups,

R³ represents H,

and

R⁸ represents a saturated or unsaturated, linear or branched, aliphatic divalent radical having up to 12 carbon atoms which may optionally contain O atoms as heteroatoms and which may optionally be substituted, for example by isocyanate-reactive groups, preferably by OH groups.

It is particularly preferable when in i)

the radical R4 represents —(C1-C12-alkyl); —(C1-C12-alkyl)-Ph or —(C1-C12-alkyl)-X, where X=an NCO-reactive group, preferably an OH group,

the radical R8 represents —(C1-C12-alkyl) or —(C1-C12-alkyl)-X, where X=an NCO-reactive group, preferably an OH group, and

the radicals R¹⁸ and/or R¹⁹ represent —(C1-C12-alkyl) or —(C1-C12-alkyl)-X, where X=an NCO-reactive group, preferably an OH group.

The following compounds of the components (I) to (IV) and (ii) are recited merely by way of example: benzyl cinnamate, hydroxyethyl acrylate (HEA), hydroxypropyl acrylate (HPA), 3-(acryloyloxy)-2-hydroxypropyl acrylate, (acryloyloxy)-2-hydroxypropyl methacrylate, crotonic anhydride, 1,4-butanediylbis[oxy(2-hydroxy-3,1-propanediyl)] 2-propanoate; ethylacrylamide; hydroxyethylacrylamide; N-methyl-N-(1,3-dihydroxypropyl)acrylamide; N-methyl-N-(2-hydroxyethyl)acrylamide; N-methyl-N-(2-hydroxypropyl)acrylamide; N-methyl-N-(2-hydroxyisopropyl)acrylamide; N-ethyl-N-(2-hydroxyethyl)acrylamide, 2-(N-methylprop-2-eneamido)acetic acid and α,β-unsaturated polyesterdiol produced by polycondensation of maleic anhydride, 1,3-propanediol and diethylene glycol in a molar ratio of 1:1:1.

It is very particularly preferable when in i)

the radical R4 represents —(C1-C12-alkyl)-X, where X=an NCO-reactive group, preferably an OH group,

the radical R8 represents —(C1-C12-alkyl)-X, where X=an NCO-reactive group, preferably an OH group, and

the radicals R¹⁸ and/or R¹⁹ represent —(C1-C12-alkyl)-X, where X=an NCO-reactive group, preferably an OH group.

Most preferred are hydroxyethyl acrylate (HEA), hydroxypropyl acrylate (HPA), 3-(acryloyloxy)-2-hydroxypropyl acrylate, 1,4-butanediylbis[oxy(2-hydroxy-3,1-propanediyl)] 2-propanoate, hydroxyethylacrylamide; N-methyl-N-(1,3-dihydroxypropyl)acrylamide; N-methyl-N-(2-hydroxyethyl)acrylamide; N-methyl-N-(2-hydroxypropyl)acrylamide; N-methyl-N-(2-hydroxyisopropyl)acrylamide; N-ethyl-N-(2-hydroxyethyl)acrylamide, 2-(N-methylprop-2-eneamido)acetic acid and α,β-unsaturated polyesterdiol produced by polycondensation of maleic anhydride, 1,3-propanediol and diethylene glycol in a molar ratio of 1:1:1 preferably having an OH number of 336 mg KOH/g, an acid number of 0.7 and a molecular weight factor per double bond of 262.

### Component C

Employed as component C are aliphatic, cycloaliphatic, araliphatic, aromatic and heterocyclic polyisocyanates, such as are described for example by W. Siefken in Justus Liebigs Annalen der Chemie, 562, pages 75 to 136, for example those of formula (V)

Q(NCO)ₙ (V)

in which
n=2-4, preferably 2-3,
and
Q is an aliphatic hydrocarbyl radical having 2-18 and preferably 6-10 carbon atoms, a cycloaliphatic hydrocarbyl radical having 4-15 and preferably 6-13 carbon atoms or an araliphatic hydrocarbyl radical having 8-15 and preferably 8-13 carbon atoms.

Concerned here are, for example, polyisocyanates as described in EP-A 0 007 502, pages 7-8. Particular preference is generally given to the readily industrially obtainable polyisocyanates, for example 2,4- and 2,6-tolylene diisocyanate and any desired mixtures of these isomers (“TDI”); polyphenylpolymethylene polyisocyanates as prepared by aniline-formaldehyde condensation and subsequent phosgenation (“crude MDI”), and polyisocyanates containing carbodiimide groups, urethane groups, allophanate groups, isocyanurate groups, uretdione groups, uretdionimine groups, urea groups or biuret groups (“modified polyisocyanates”), especially those modified polyisocyanates which derive from 2,4- and/or 2,6-tolylene diisocyanate or from 4,4′- and/or 2,4′-diphenylmethane diisocyanate. Preferably employed as component B is at least one compound selected from the group consisting of 2,4- and 2,6-tolylene diisocyanate, 4,4′- and 2,4′- and 2,2′-diphenylmethane diisocyanate and polyphenyl polymethylene polyisocyanate (“polycyclic MDI”).

Very particularly preferably employed as component C is a diphenylmethane diisocyanate mixture consisting of
a) 45% to 90% by weight of 4,4′-diphenylmethane diisocyanate and
b) 10% to 55% by weight of 2,2′-diphenylmethane diisocyanate and/or 2,4′-diphenylmethane diisocyanate and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

Employed as component C in an alternative very particularly preferred embodiment is a diphenylmethane diisocyanate mixture consisting of
a) 35% to 45% by weight of 4,4′-diphenylmethane diisocyanate and
b) 1% to 5% by weight of 2,2′-diphenylmethane diisocyanate and/or 2,4′-diphenylmethane diisocyanate and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

### Performance of the Process for Producing Polyurethane Foams:

The reaction components are reacted by the one-step process known per se, the prepolymer process or the semiprepolymer process often using mechanical means, for example those described in EP-A 355 000. Details of processing apparatuses which are also suitable in accordance with the invention are described in Kunststoff-Handbuch, volume VII, edited by Vieweg and Höchtlen, Carl-Hanser-Verlag, Munich 1993, for example on pages 139 to 265.

The isocyanate-reactive component B may for example initially be reacted with the isocyanate component C to afford a prepolymer and subsequently foamed with the polyol formulation A. A further option is that of initially mixing the isocyanate-reactive component B with the polyol formulation A and subsequently foaming with the isocyanate component C.

Preference is given to initially reacting the isocyanate-reactive component B with the isocyanate component C to afford a prepolymer and subsequently foaming the prepolymer with the polyol formulation A.

The PUR foams may be produced as molded foams or else as slabstock foams.

The molded foams may be produced by hot curing or else cold curing.

The invention therefore provides a process for producing the polyurethane foams, provides the polyurethane foams produced by this process, provides for the use of said foams for producing moldings or slabstocks and provides the moldings/the slabstocks themselves.

The polyurethane foams obtainable according to the invention find use for example in: furniture cushioning, textile inserts, mattresses, automotive seats, headrests, armrests, sponges and constructional elements and also seat and instrument panel trims, and have indices of 70 to 130, preferably 80 to 120, and densities of 4 to 600 kg/m³, preferably 60 to 120 kg/m³ (flexible foam) or 15 to 55 (semi-rigid foam).

The index (isocyanate index) indicates the percentage ratio of the actually employed isocyanate amount to the stoichiometric, i.e. calculated, isocyanate groups (NCO) amount:

Index=[(employed isocyanate amount):(calculated isocyanate amount)]·100 (VI)

### EXAMPLES

### Production of the Foams:

The ratio of isocyanate groups to isocyanate-reactive groups multiplied by 100 is described as the index. The following tests always compare foams produced using the same index. In two test series an index below 100 (excess of isocyanate-reactive groups) and an index above 100 were established.

To produce the foams the required amount of polyol is initially charged into a cardboard beaker having a sheet metal bottom (volume: about 850 ml) and loaded with air using a stirring means (Pendraulik) fitted with a standard stirring disk (d=64 mm) at 4200 rpm for 45 seconds. Homogenization is carried out using a Pendraulik standard stirring disk (diameter 64 mm). The isocyanate/isocyanate mixture/prepolymer is weighed into a suitable beaker and emptied again (efflux time: 3 s). This beaker still having wet internal walls is tared and refilled with the reported isocyanate quantity. The isocyanate is added to the polyol formulation (efflux time: 3 s). The mixture is subjected to intensive mixing for 5 seconds using a stirring means (Pendraulik). A stopwatch is started at commencement of the mixing and the characteristic reaction times are read-off therefrom. About 93 g of the reaction mixture are poured into a teflon film-lined aluminum box mold having a volume of 1.6 dm³ and a temperature of 23° C. The mold is closed and locked. After six minutes the mold is unlocked, decompressed and the mold pressure is qualitatively assessed via the height by which the mold lid has been raised by the molding [mm]. The demolded foam cushion is qualitatively assessed for reaction completeness and for skin and pore structure. The reaction kinetics are determined using the residual reaction mixture in the beaker.
The cream time has been attained when a first foaming of the mixture is observable. This indicates the beginning of the reaction between isocyanate and water.
The fiber time has been attained when strings can be pulled from the surface of the rising foam by dabbing with a wooden spatula. Alternatively, lumps form on the wooden spatula.
The rise time has been attained when the foam finally ceases to expand. It should be noted here that some systems have a propensity to undergo some sagging before rising again.

### Conditioning of the Foams:

After production all foams were stored in a fume cupboard at 20-23° C. for 7 days.

Some of the foams were packaged in aluminum foil and stored in a circulating air drying cabinet at 90° C. before measurement of the aldehyde emissions. These foams are described as “aged”.

### Mechanical Characterization of the Foams

Compressive strength and damping were measured on test specimens having dimensions of 5*5*5 cm³ parallel to the foaming direction at 40% compression. A pre-loading of 2 kPa was established.

The advancing rate was 50 mm/min.

Hydroxyl number was determined to DIN 53240.

### Test Methods:

### Determination of Aldehyde Emissions:

a) Measurement Method 1 (Bottle Method According to VDA 275):
50 milliliters of water are charged into a glass bottle of 1 liter in volume. A foam sheet having dimensions of 40*10*2 cm³ is secured freely suspended from the lid so that the foam is not in contact with the aqueous solution at the bottom of the bottle. The bottle is closed and stored in a recirculating air drying cabinet at 60° C. for 3 hours. The bottle is allowed to cool to room temperature and the foam is withdrawn. An aliquot of the aqueous solution is reacted with a solution of 0.3 mmol/liter of dinitrophenylhydrazine (DNPH) in 3 mM phosphoric acid-acidified acetonitrile. The composition of the aqueous solution is analyzed by LC-MS/MS for the hydrazones of the aldehydes recited below. For each foam quality three bottles are analyzed. For each test run three bottles without foam are coanalyzed. The average reference value is subtracted from the measured values. The emission of the respective aldehydes per kilogram of foam is extrapolated on this basis. This is reported in mg of aldehyde per kg of foam.

b) Measurement Method 2 (Modified Bottle Method):
Charged into a glass bottle of one liter in volume are 25 milliliters of water and 25 milliliters of a solution of 0.3 mmol/liter of dinitrophenylhydrazine (DNPH) in 3 mM phosphoric acid-acidified acetonitrile. The content of DNPH is 7.5 μmol per bottle. A foam sheet having dimensions of 40*10*4 cm³ is secured freely suspended from the lid so that the foam is not in contact with the aqueous solution at the bottom of the bottle. The bottle is closed and stored in a recirculating air drying cabinet at 65° C. for 3 hours. The bottle is allowed to cool to room temperature, the foam is withdrawn and the composition of the aqueous solution is analyzed by LC/MS-MS for the hydrazones of the aldehydes recited below. For each foam quality three bottles are analyzed. For each test run three bottles without foam are coanalyzed. The average reference value is subtracted from the measured values. The emission of the respective aldehydes per kilogram of foam is extrapolated on this basis. This is reported in mg of aldehyde per kg of foam.

For illustration of the methods the emissions for the combination of the standard polyol formulation with isocyanate B1 are shown below:

Formaldehyde

| | | | VDA275 | | Improvement in |
|---|---|---|---|---|---|
| storage | Index | VDA275 | modified | | visibility |
| 7 days at | 90 | 4.0 | 7.5 | mg/kg | 88% |
| 20-23° C. | 105 | 3.5 | 5.6 | mg/kg | 60% |
| 11 days at | 90 | 3.7 | 7.6 | mg/kg | 105% |
| 90° C. and | 105 | 3.9 | 9.4 | mg/kg | 141% |
| 7 days at | | | | | |
| 20-23° C. | | | | | |

Acetaldehyde

| | | | VDA275 | | Improvement in |
|---|---|---|---|---|---|
| storage | Index | VDA275 | modified | | visibility |
| 7 days at | 90 | 0.5 | 1.1 | mg/kg | 120% |
| 20-23° C. | 105 | 0.3 | 0.8 | mg/kg | 167% |
| 11 days at | 90 | 0.6 | 1.5 | mg/kg | 150% |
| 90° C. and | 105 | 0.6 | 1.8 | mg/kg | 200% |
| 7 days at | | | | | |
| 20-23° C. | | | | | |

### Description of Raw Materials

### Polyol Component:

The polyol component employed was a polyether mixture of a glycerol-started polyalkylene oxide having a molar weight of 4.8 kg/mol and a propylene glycol-started polyalkylene oxide having a molar weight of 4 kg/mol. The weight ratio of the two polyethers was 55:45.

The polyol component further contains various additive substances.
Color paste is black paste Isopur N (ISL Chemie),
Foam stabilizer is Tegostab B8734LF2 (Evonik),
Cell opener is glycerol-started polyalkylene oxide having an OH number of 37 mg KOH/g.
Triethanolamine was used as crosslinker.
Water was used as blowing agent.
The catalysts used were a mixture of Jeffcat DPA from Huntsman and Dabco NE 300 from
Air Products (6:1 by weight).

% by weight in polyol component

| | |
|---|---|
| Polyether mixture | 91.53 |
| Cell opener | 1.53 |
| Color paste | 0.21 |
| Foam stabilizer | 0.77 |
| Crosslinker | 0.62 |
| Blowing agent | 3.91 |
| Catalyst | 1.44 |

Isocyanates:

| | |
|---|---|
| B1 | Is a commercially available mixture of MDI |
| (comparative) | isomers and homologs having a density of |
| | 1.24 kg/liter, an isocyanate content of 323 |
| | g/kg and a viscosity of 0.05 Pa*s. The |
| | content of 4,4′-MDI is 60% by weight. |
| B2 | Consists of 92.54% by weight of isocyanate |
| (comparative) | V and 7.46% by weight of 97% monoethylene |
| | glycol methacrylate (Aldrich). The isocyanate |
| | content is 272 g/kg and the viscosity is |
| | 0.12 Pa*s (25° C.). |
| B3 | Consists of 92.55% by weight of isocyanate |
| (inventive) | V and 7.45% by weight of hydroxypropyl |
| | acrylate 95% (isomer mixture, Aldrich). |
| | The isocyanate content is 272 g/kg and the |
| | viscosity is 0.13 Pa*s (25° C.). |
| B4 | Consists of 92.97% by weight of isocyanate |
| (inventive) | V and 7.03% by weight of 96% hydroxyethyl |
| | acrylate (Aldrich). The isocyanate content is |
| | 272 g/kg and a viscosity is 0.12 Pa*s (25° C.). |

### Results

Index 90

| | | B2 | B3 | B4 | B1 | B1 |
|---|---|---|---|---|---|---|
| Isocyanate | | comparative | inventive | inventive | inventive | comparative |
| Addition to the | | none | none | none | 50 g | none |
| base polyol | | | | | HEAA/kg | |
| Cream time | seconds | 12 | 12 | 12 | 12 | 10 |
| Fiber time | seconds | 62 | 61 | 61 | 54 | 50 |
| Rise time | seconds | 93 | 90 | 89 | 71 | 69 |
| Lid lift | mm | 10 | 10 | 10 | 10 | 10 |
| Apparent core | kg/m³ | 51 | 51 | 51 | 47 | 49 |
| density | | | | | | |
| Indentation | kPa | 11 | 7 | 7 | 8 | 9 |
| hardness | | | | | | |
| Damping | % | 46 | 46 | 45 | 37 | 37 |
| Acetaldehyde | mg/kg | 1.1 | 0.6 | 0.5 | 0.6 | 1.1 |

HEAA is hydroxyethylacrylamide (Aldrich)

In contrast to isocyanates B3 and B4 no activity of the isocyanate B2 on acetaldehyde emissions is detectable.

Index 105

| | | B2 | B3 | B4 | B1 | B1 |
|---|---|---|---|---|---|---|
| Isocyanate | | comparative | inventive | inventive | inventive | comparative |
| Addition to the | | none | none | none | 50 g | none |
| base polyol | | | | | HEAA/kg | |
| Cream time | seconds | 13 | 12 | 12 | 12 | 10 |
| Fiber time | seconds | 66 | 64 | 66 | 54 | 51 |
| Rise time | seconds | 98 | 101 | 107 | 75 | 70 |
| Lid lift | mm | 10 | 10 | 10 | 10 | 10 |
| Apparent core | kg/m³ | 53 | 50 | 51 | 49 | 49 |
| density | | | | | | |
| Indentation | kPa | 13 | 11 | 12 | 15 | 14 |
| hardness | | | | | | |
| Damping | % | 53 | 52 | 51 | 49 | 44 |
| Acetaldehyde | mg/kg | 0.9 | 0.6 | 0.7 | 0.6 | 0.8 |

At higher indices the differences are less marked yet still apparent. In contrast to isocyanates B3 and B4, no activity of the isocyanate B2 on acetaldehyde emissions is detectable even at elevated indices.

1. A process for producing polyurethanes comprising reacting A) one or more compounds containing isocyanate-reactive hydrogen atoms with C) di- and/or polyisocyanates in the presence of B) one or more α,β-unsaturated carboxylic esters and/or amides, wherein the resultant polyurethanes exhibit reduced aldehyde emissions as measured by the VDA 275 modified bottle method.

2. The process as claimed in claim 1, wherein the one or more α,β-unsaturated carboxylic esters/amides are selected from:
i) one or more compounds selected from the group consisting of
R¹R²C═CR³—C(O)—O—R⁴ (I.),
R⁵R⁶C═CR⁷—C(O)—O—R⁸—O—(O)C—R⁹C═CR¹⁰R¹¹ (II.),
R¹²R¹³C═CR¹⁴—C(O)—O—(O)C—R¹⁴C═CR¹³R¹² (III.)
and
R¹⁵R¹⁶C═CR¹⁷—C(O)—NR¹⁸—R¹⁹ (IV.),
wherein
R¹ and R², R⁴ to R⁷ and R⁹ to R¹⁹ independently of one another represent H, a saturated or unsaturated, linear or branched, aliphatic or cycloaliphatic or an aromatic or araliphatic radical having up to 20 carbon atoms, each of which is unsubstituted or is substituted with one or more isocyanate-reactive groups, or which optionally contains one or more heteroatoms,
R³ represents H,
and
R⁸ represents a saturated or unsaturated, linear or branched, aliphatic divalent radical having up to 20 carbon atoms, each of which is unsubstituted or is substituted by one or more isocyanate-reactive groups, or which optionally contains one or more heteroatoms,
or
ii) polyester polyols obtainable by polycondensation of maleic acid, fumaric acid, methacrylic acid or acrylic acid with diols and/or triols, said polyester polyols having a number average molecular weight factor per double bond of 150 to 3000, a functionality of 2 to 6, a hydroxyl number of 20 to 800 and an acid number of 0 to 15.

3. The process as claimed in claim 2, wherein component A) comprises:
A1 one or more compounds containing isocyanate-reactive hydrogen atoms having an OH number according to DIN 53240 of ≥15 to <260 mg KOH/g,
A2 optionally one or more compounds containing isocyanate-reactive hydrogen atoms having an OH number according to DIN 53240 of ≥260 to <4000 mg KOH/g,
A3 water and/or physical blowing agents,
A4 auxiliary and/or additive substances selected from
a) catalysts,
b) surface-active additive substances,
c) pigments and/or flame retardants,
wherein free-radical initiators and catalysts which catalyze a vinylic polymerization are excluded.

4. The process as claimed in claim 2, wherein component A) comprises:
A1 75 to 99.3 parts by weight (based on the sum of the parts by weight of components A1 to A4) of one or more compounds containing isocyanate-reactive hydrogen atoms having an OH number according to DIN 53240 of ≥15 to <260 mg KOH/g,
A2 0 to 10 parts by weight (based on the sum of the parts by weight of components A1 to A4) of one or more compounds containing isocyanate-reactive hydrogen atoms having an OH number according to DIN 53240 of ≥260 to <4000 mg KOH/g,
A3 0.5 to 24.8 parts by weight (based on the sum of the parts by weight of components A1 to A4) of water and/or physical blowing agents,
A4 0.2 to 10 parts by weight (based on the sum of the parts by weight of components A1 to A4) of auxiliary and/or additive substances which are selected from the group consisting of
a) catalysts,
b) surface-active additive substances, and
c) pigments and/or flame retardants,
wherein free-radical initiators and catalysts which catalyze a vinylic polymerization are excluded,
and component B) is present in an amount of from 1 to 100 g per kg of the components A1 and C),
wherein all reported parts by weight for the components A1 to A4 are normalized such that the sum of the parts by weight of the components A1+A2+A3+A4 in the composition adds up to 100.

5. The process as claimed in claim 2, wherein component A) comprises:
A1 25 to 45 parts by weight (based on the sum of the parts by weight of components A1 to A4) of one or more compounds containing isocyanate-reactive hydrogen atoms having an OH number according to DIN 53240 of ≥15 to <260 mg KOH/g,
A2 20 to 74.3 parts by weight (based on the sum of the parts by weight of components A1 to A4) of one or more compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents,
A4 0.2 to 10 parts by weight (based on the sum of the parts by weight of components A1 to A4) of auxiliary and/or additive substances which are selected from the group consisting of
a) catalysts,
b) surface-active additive substances,
and
c) pigments and/or flame retardants,
wherein free-radical initiators and catalysts which catalyze a vinylic polymerization are excluded,
and component B) is present in an amount of from 1 to 100 g per kg of the components A1 and C),
wherein all reported parts by weight for the components A1 to A4 are normalized such that the sum of the parts by weight of the components A1+A2+A3+A4 in the composition adds up to 100.

6. A process for producing polyurethane foams comprising reacting, A) one or more compounds containing isocyanate-reactive hydrogen atoms with a component C) comprising di- and/or polyisocyanates, in the presence of B) one or more α,β-unsaturated carboxamides.

7. The process as claimed in claim 6, comprising reacting A) one or more compounds containing isocyanate-reactive hydrogen atoms with C) di- and/or polyisocyanates in the presence of B) one or more α,β-unsaturated carboxamides which comprise one or more compounds corresponding to the formula
R¹⁵R¹⁶C═CR¹⁷—C(O)—NR¹⁸—R¹⁹ (IV.),
wherein
R¹⁵ to R¹⁹ independently of one another represent H, a saturated or unsaturated, linear or branched, aliphatic or cycloaliphatic or an aromatic or araliphatic radical having up to 20 carbon atoms, each of which is unsubstituted or is
substituted by isocyanate-reactive groups or which are optionally contains one or more heteroatoms.

8. The process for producing polyurethane foams as claimed in claim 7 in which a component A comprises
A1 one or more compounds containing isocyanate-reactive hydrogen atoms having an OH number according to DIN 53240 of ≥15 to <260 mg KOH/g,
A2 optionally one or more compounds containing isocyanate-reactive hydrogen atoms having an OH number according to DIN 53240 of ≥260 to <4000 mg KOH/g,
A3 water and/or physical blowing agents,
A4 auxiliary and/or additive substances which are selected from the group consisting of
a) catalysts,
b) surface-active additive substances,
and
c) pigments and/or flame retardants,
wherein free-radical initiators and catalysts which catalyze a vinylic polymerization are excluded.

9. The process as claimed in claim 7 wherein component A) comprises
A1 75 to 99.3 parts by weight (based on the sum of the parts by weight of components A1 to A4) of one or more compounds containing isocyanate-reactive hydrogen atoms having an OH number according to DIN 53240 of ≥15 to <260 mg KOH/g,
A2 0 to 10 parts by weight (based on the sum of the parts by weight of components A1 to A4) of one or more compounds containing isocyanate-reactive hydrogen atoms having an OH number according to DIN 53240 of ≥260 to <4000 mg KOH/g,
A3 0.5 to 24.8 parts by weight (based on the sum of the parts by weight of components A1 to A4) of water and/or physical blowing agents,
A4 0.2 to 10 parts by weight (based on the sum of the parts by weight of components A1 to A4) of auxiliary and/or additive substances which are selected from the group consisting of
a) catalysts,
b) surface-active additive substances,
and
c) pigments and/or flame retardants,
wherein free-radical initiators and catalysts which catalyze a vinylic polymerization are excluded,
and
component B) is present in an amount of from 1 to 100 g per kg of the components A1 and C, wherein component B comprises one or more compounds corresponding to formula (IV)
and wherein all reported parts by weight for the components A1 to A4 are normalized such that the sum of the parts by weight of the components A1+A2+A3+A4 in the composition adds up to 100.

10. The process as claimed in claim 7 wherein component A) comprises
A1 25 to 45 parts by weight (based on the sum of the parts by weight of components A1 to A4) of one or more compounds containing isocyanate-reactive hydrogen atoms having an OH number according to DIN 53240 of ≥15 to <260 mg KOH/g,
A2 20 to 74.3 parts by weight (based on the sum of the parts by weight of components A1 to A4) of one or more compounds containing isocyanate-reactive hydrogen atoms having an OH number according to DIN 53240 of ≥260 to <4000 mg KOH/g,
A3 0.5 to 25 parts by weight (based on the sum of the parts by weight of components A1 to A4) of water and/or physical blowing agents, preferably 2-7 parts by weight of water,
A4 0.2 to 10 parts by weight (based on the sum of the parts by weight of components A1 to A4) of auxiliary and/or additive substances which are selected from the group consisting of
a) catalysts,
b) surface-active additive substances,
and
c) pigments and/or flame retardants,
wherein free-radical initiators and catalysts which catalyze a vinylic polymerization are excluded,
and
component B) is present in an amount of from 1 to 100 g per kg of the components A1 and C, wherein component B) comprises one or more compounds corresponding to formula (IV),
wherein all reported parts by weight for the components A1 to A4 are normalized such that the sum of the parts by weight of the components A1+A2+A3+A4 in the composition adds up to 100.

11. The process as claimed in claim 2, wherein
the radicals R¹ and R², R⁵ to R⁷ and R⁹ to R¹⁸ independently of one another represent H, a saturated or unsaturated, linear or branched, aliphatic or cycloaliphatic or an aromatic or araliphatic radical having up to 12 carbon atoms, each of which is unsubstituted or which or which is substituted with one or more isocyanate-reactive groups, or which optionally contains one or more O atoms,
the radical R³ represents H,
the radical R⁴ represents —(C1-C12-alkyl); —(C1-C12-alkyl)-Ph or —(C1-C12-alkyl)-X, where X=represents an NCO-reactive group, and
the radicals R¹⁸ and R¹⁹ independently of one another represent —(C1-C12-alkyl) or —(C1-C12-alkyl)-X, where X=represents an NCO-reactive group.

12. The process as claimed in claim 11, wherein component B) comprises at least one of benzyl cinnamate, hydroxyethyl acrylate (HEA), hydroxypropyl acrylate (HPA), 3-(acryloyloxy)-2-hydroxypropyl acrylate, (acryloyloxy)-2-hydroxypropyl methacrylate, crotonic anhydride, 1,4-butanediylbis[oxy(2-hydroxy-3,1-propanediyl)] 2-propanoate; ethylacrylamide; hydroxyethylacrylamide; N-methyl-N-(1,3-dihydroxypropyl)acrylamide; N-methyl-N-(2-hydroxyethyl)acrylamide; N-methyl-N-(2-hydroxypropyl)acrylamide; N-methyl-N-(2-hydroxyisopropyl)acrylamide; N-ethyl-N-(2-hydroxyethyl)acrylamide, 2-(N-methylprop-2-eneamido)acetic acid; or an α,β-unsaturated polyesterdiol produced by polycondensation of maleic anhydride, 1,3-propanediol and diethylene glycol in a molar ratio of 1:1:1.

13. The process as claimed in any claim 3, wherein component A1 said one or more compounds containing isocyanate-reactive hydrogen atoms comprises at least two hydroxyl-containing polyethers, optionally in admixture with at least two hydroxyl-containing polyesters.

14. The process as claimed in claim 3, wherein component A1 comprises at least 30% by weight of at least one polyoxyalkylene copolymer which comprises the reaction product of a starter, propylene oxide and ethylene oxide and an end block composed of ethylene oxide, wherein the total weight of the end blocks is on average 3-20% by weight, based on the total weight of all polyoxyalkylene copolymers.

15. The process as claimed in claim 3, wherein said di- and/or polyisocyanate component of C) comprises a diphenylmethane diisocyanate mixture comprising
a) 45% to 90% by weight of 4,4′-diphenylmethane diisocyanate,
b) 10% to 55% by weight of 2,2′-diphenylmethane diisocyanate and/or 2,4′-diphenylmethane diisocyanate,
and
c) 0% to 45% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

16. The process as claimed in claim 3, wherein said di- and/or polyisocyanate component comprises a diphenylmethane diisocyanate mixture comprising
a) 35% to 45% by weight of 4,4′-diphenylmethane diisocyanate,
b) 1% to 5% by weight of 2,2′-diphenylmethane diisocyanate and/or 2,4′-diphenylmethane diisocyanate,
and
c) 50% to 64% by weight of polyphenylpolymethylene polyisocyanate (“polycyclic MDI”) and/or 2,2′-, 2,4′-, 4,4′-diphenylmethane diisocyanate-based and/or pMDI-based carbodiimides, uretdiones or uretdioneimines.

17. A polyurethane/polyurethane foam obtainable by a process as claimed in claim 6.

18. The polyurethane/polyurethane foam as claimed in claim 17 having a density of 4 to 600 kg/m³.

19. An article comprising the polyurethane foams having reduced aldehyde emission obtainable as claimed in claim 6 in furniture cushioning, textile inserts, bedding, automotive, sponges, door panels, seat covers, or construction elements.
